(19) United States
(12) Patent Application Publication
(10) Pub. No.: US 2001/0049734 A1
(43) Pub. Date: Dec. 6, 2001

(54) Use-limitation homepage providing system

(76) Inventors: Youko Suwabe, Yokohama-shi (JP); Masao Isshiki, Tokyo (JP); Yuka Yoda, Yokohama-shi (JP); Morio Hirahara, Yokohama-shi (JP); Takuya Kishimoto, Ibaraki-shi (JP); Mitsuo Takahashi, Yokohama-shi (JP)

Correspondence Address: Roger R. Wise, PILLSBURY MADISON & SUTRO, Suite 1200, 725 South Figueroa Street, Los Angeles, CA, 90017, US

(21) Appl. No.: 09/863,844

(22) Filed: May 23, 2001

(30) Foreign Application Priority Data
May 29, 2000 (JP) P2000-158678

(51) Int. Cl. G06F 15/173

(52) U.S. Cl. 709/225

(57) ABSTRACT

In the use-limitation homepage providing system, the communication terminal (15) reads barcode data on the card (21) and transmits product identification information therein and IP address of the terminal (15) to the URL conversion server (17) through the Internet (11). The URL conversion server (17) obtains URL address of the management server (19) corresponding to the received product identification:information and transmits the product identification information and IP address of the communication terminal (15) to the management server (19) addressed by URL address. When receiving the product identification information through the URL conversion server (17), the management server (19) transmits a permission to access a use-limitation homepage corresponding to the product identification information.

### CROSS-REFERENCE TO RELATED APPLICATION

This application is based upon and claims the benefit of priority from the prior Japanese Patent Application No. 2000-158678, filed May 29, 2000; the entire contents of which are incorporated herein by reference.

### BACKGROUND OF THE INVENTION

1. Field of the Invention

The present invention relates to a use-limitation homepage providing system, and, more particularly, to a use-limitation homepage providing system that permits card users to access the use-limitation homepage.

2. Description of the Related Art

Recently, the Internet has grown exponentially and many homepages and servers storing those homepages are widely available. Thereby, users can access various homepages and advertisers servers. Those homepages can be divided to three categories: Pricing homepages (pay-of-charge homepages) in which a user must pay when accessing it; Use-limitation home pages that limits users according to desires conditions; and Free-of-charge homepages (hereinafter, referred to as “free homepages”).

There are various methods to access conventional pay homepages for which the user is not authorized (having no contrast). For example, the user inputs the number of the own credit card on the home page, or the user inputs the ID number written in a prepaid card, or the user sends a money for access charges through a post office, a bank, a convenience store, and the like.

There are also other methods to access the conventional homepages. For example, the users have no charges only during a desired period from the introduction of a pay homepage in order to obtain many users. In this case, the users must pay it after the elapse of the desired period. In particularly, advertisements send direct mails or questionnaires to users in order to get the users who want to access the homepages.

However, the method of accessing the pay homepages (for which the user is not authorized in access (having no contract) by inputting and then sending the number of the credit card includes a drawback in safety and security. In addition, the conventional methods has a drawback that it is difficult for the user to find an authorized shop to sell an available prepaid card, and a drawback that the user must go to a post office, a bank, or a convenience store in order to send a usage charge during the business hours. Further, the conventional method has a drawback that it is difficult for the user to go to the shop during the window service hours or the business hours. This causes that the user cannot access the target homepage immediately when he wants. Furthermore, there are other drawbacks that the users cannot find or difficult to find the Uniform Resource Locater (URL as an electronic address on the Internet) of a target pay homepage.

Moreover, when the users must input the URL of a target pay homepage directly through a keyboard in a home personal computer (PC), complicated operation is necessary to input the URL of the target pay homepage. On the other hand, it is also difficult for the advertisers providing the pay homepages to get the users who want to access them.

### SUMMARY OF THE INVENTION

Accordingly, an object of the present invention is, with due consideration to the drawbacks of the conventional technique described above, to provide a use-limitation homepage providing system by which card users access use-limitation homepages with easy operation.

According to an aspect of the present invention, a use-limitation homepage providing system connects a communication terminal to a URL conversion server and to a management server in order and provides a use-limitation homepage in homepages stored in the management server to the communication terminal through an information network. The communication terminal comprises a barcode reader which reads a barcode printed on a card on which the barcode including identification information is printed, and a first communication processing section which transmits the identification information in the card and IP address of the communication terminal to the URL conversion server. The URL conversion server comprises an address conversion section which converts the identification information to URL address of the management server corresponding to this identification information transmitted from the communication terminal, and a second communication processing section which transmits the identification information transmitted from the communication terminal and the IP address of the communication terminal to the management server addressed by the URL address of the management server. The management server comprises an access permission section which transmits permission information regarding the permission to access the use-limitation homepage corresponding to the identification information to the communication terminal addressed by the IP address when the management server receives the identification information through the URL conversion server.

### BRIEF DESCRIPTION OF THE DRAWINGS

These and other objects, features, aspects and advantages of the present invention will become more apparent from the following detailed description of the present invention when taken in conjunction with the accompanying drawings, in which:

FIG. 1 is a diagram showing a configuration of a user-limitation homepage providing system according to the first embodiment of the present invention;

FIG. 2 is a diagram showing a characteristic of a card to be used by a user in the first embodiment;

FIG. 3 is a block diagram of a configuration of a communication terminal as a consumer side;

FIG. 4 is a block diagram showing a configuration of a URL conversion server;

FIG. 5 is a block diagram showing a configuration of a management server;

FIG. 6 is a flow chart depicting the procedure of the user-limitation homepage providing system according to the first embodiment;

FIG. 7 is a diagram showing a characteristic of a card to be used by a user in the second embodiment;

FIGS. 8A, 8B are a flow chart depicting the procedure of the user-limitation homepage providing system according to the second embodiment;

FIG. 9 is a diagram showing a characteristic of a card to be used by a user in the third embodiment;

FIGS. 10A, 10B are a flow chart depicting the procedure of the user-limitation homepage providing system according to the third embodiment;

FIG. 11 is a diagram showing a characteristic of a card to be used by a user according to the fourth embodiment; and

FIGS. 12A, 12B are a flow chart depicting the procedure of the user-limitation homepage providing system according to the fourth embodiment.

### DESCRIPTION OF THE PREFERRED EMBODIMENTS

Other features of this invention will become apparent through the following description of preferred embodiments which are given for illustration of the invention and are not intended to be limiting thereof.

### First Embodiment

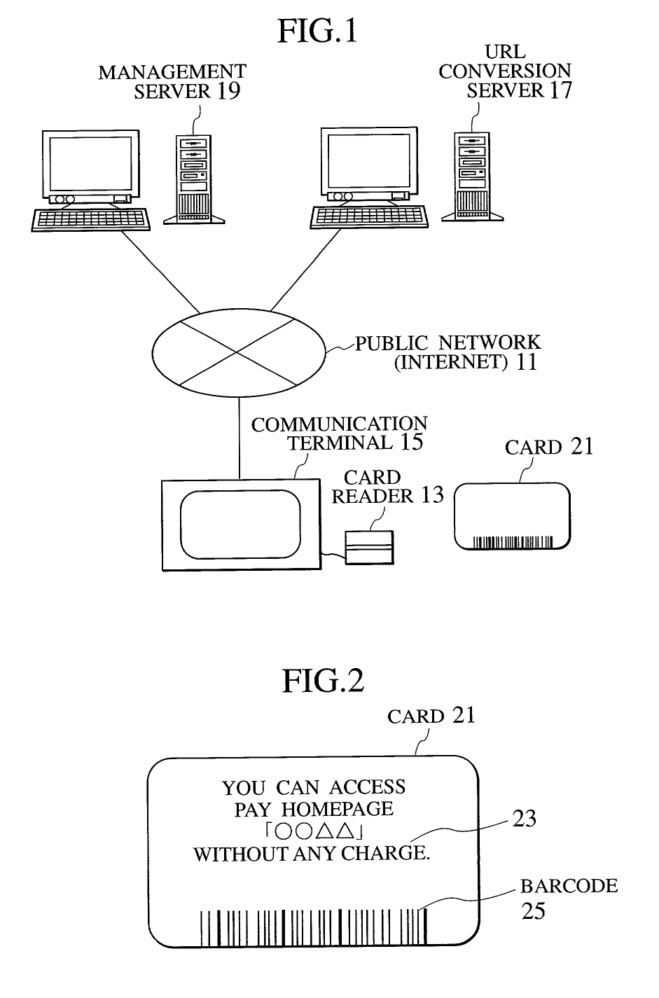

FIG. 1 is a diagram showing a configuration of a user-limitation homepage providing system according to the first embodiment of the present invention. This system uses the Internet 11 as an information network to which a communication terminal 15 for a user, a URL server 17, and a management server 19 are connected. The communication terminal 15 is connected to a card reader 13 to read a card. The management server 19 manages a pay homepage (as a pay-of-charge homepage).

FIG. 2 is a diagram showing a characteristic of the card 21 on which the character information such as the sentence “You can access the pay homepage “◯◯ΔΔ” without any charge” are printed or image information (omitted here) is printed. The card reader 13 reads this card 21. For example, this card for accessing the pay homepage without any charge is attached to a product in advance. When buying this product, the user can use this card attached to the product. On this card 21, a barcode 25 is printed as numerical information including product identification information to distinguish this product from other products. It is also possible to use a paper on which plural barcodes are printed instead of the card 21.

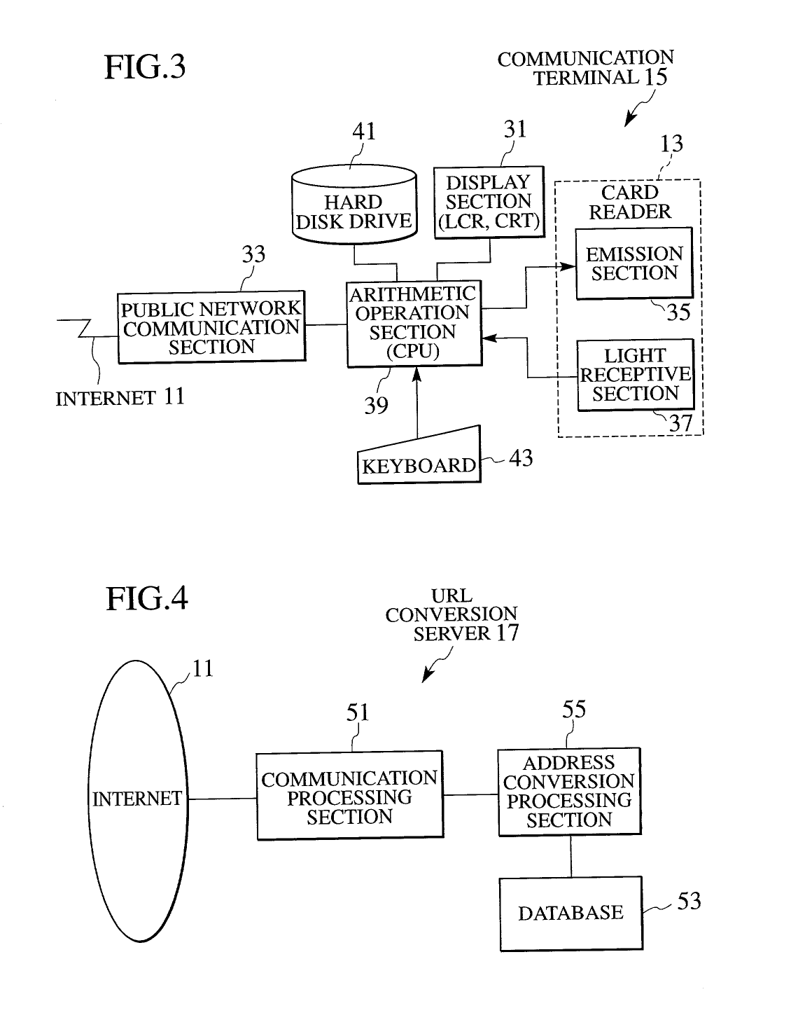

FIG. 3 is a block diagram of the configuration of the communication terminal 15 as a consumer side. As shown in FIG. 3, the communication terminal 15 is a general-purpose personal computer (PC) with the card reader 13 to read the barcode data on the card 21. The communication terminal 15 comprises a display section 31, a public network communication section 33 to connect the Internet as the information network, an emission section 35 for emitting the barcode 25 on the card 21, a light receptive section 37 for receiving a light reflected from the card 21, an arithmetic operation section 39 (CPU) for extracting a product identification information from the barcode data and performing required communication processing, a hard disk drive 41 for storing control programs and control data to control the entire operation of the communication terminal, and a keyboard 43. It is also possible for the card reader 13 to read a paper on which plural barcodes are printed instead of the card 21.

When the power of the system is turned ON, a control program is red from the hard disk drive 41 to the arithmetic section operation 39 and then the operating guidance is displayed on the display section 31. The user puts the card 21 in the card reader 13 according to the operating guidance, and the card reader 13 reads the barcode on the card 21 and extracts the product identification information from it. Then the system accesses the URL of the URL conversion server through the Internet based on the product identification information and sends the product identification information and the IP (internet Protocol) address of the device about the communication terminal 15. The display section 31 is capable of displaying the information (that are stored in the homepage addressed by the URL address) transmitted from the management server 19.

FIG. 4 is a block diagram showing the configuration of the URL conversion server 17. As shown in FIG. 4, the URL conversion server 17 has the inherent URL address in the Internet 11. The URL conversion server 17 comprises a communication control section 51, a database 53, and an address conversion processing section 55. The communication control section 51 controls the access to this URL address. The database 53 stores correspondence data, each correspondence data item indicates the relationship between the product identification information in the barcode transmitted to the URL address and the URL address assigned for each product identification information, in order to distinguish this product from other products. The address conversion processing section 55 searches the database 53 based on the product identification information transmitted from the communication terminal 15, and retrieves the URL address corresponding to this product identification information, and accesses the homepage indicated by this URL address.

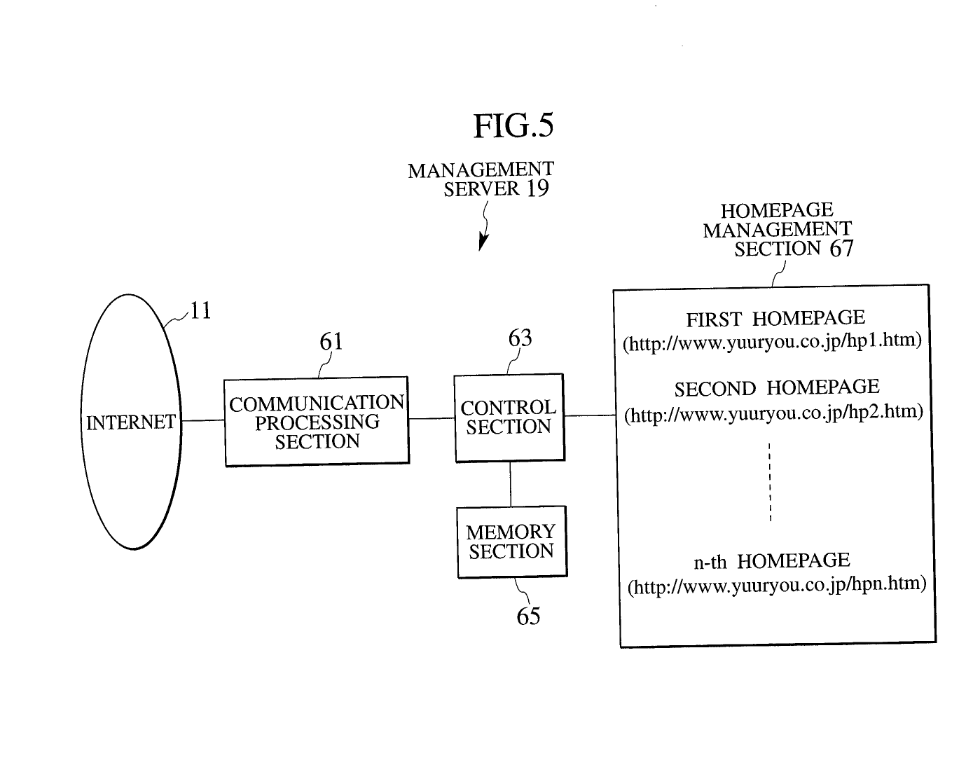

FIG. 5 is a block diagram showing the configuration of the management server 19. As shown in FIG. 5, the management server 19 comprises a communication processing section 61, a control section 63, a memory section 65 storing the URL address of the URL conversion server 17 as one data item in connection path data in advance, and a homepage management section 67. The communication processing section 61 performs the communication processing to the Internet 11 in order to access a target pay homepage or a target use-limitation homepage. The control section 63 judges whether or not connection path data transmitted through the Internet include the URL address of the URL conversion server 17 that has been stored in the memory section 65 in advance, and then gives the permission of the connection when the connection path data include it. The homepage management section 67 provides the homepage designated by the URL address per product identification information on the Internet.

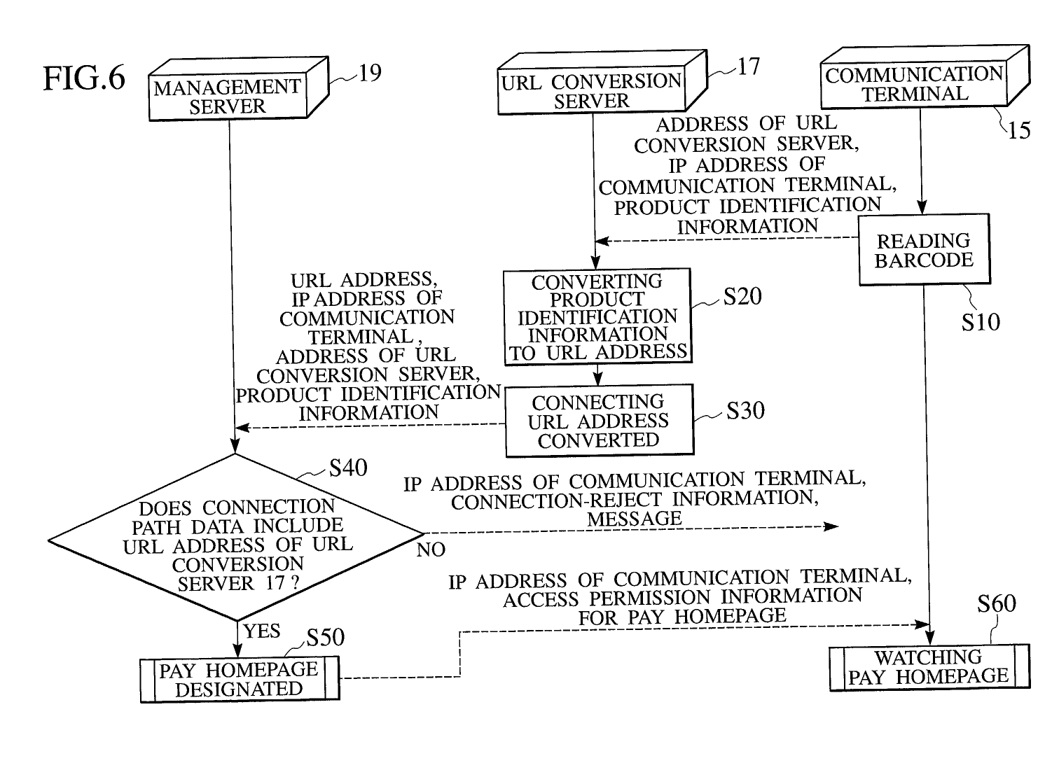

Next, a description will be given of the operation of the use-limitation homepage providing system of the first embodiment with reference to the flowchart of FIG. 6. FIG. 6 is the flow chart depicting the procedure of the user-limitation homepage providing system of the first embodiment.

The communication terminal 15, the URL conversion server 17, and the management server 19 perform the processes corresponding to each step shown in FIG. 6.

In the following example case, the user buys a product with the card 21 attached in advance capable of accessing the pay homepage or the use-limitation homepage, and the user unpacks the card 21 from this product. The user then finds the card 21 in the product on which the character information 23 “You can access the pay homepage “◯◯ΔΔ” without any charge!” is described, and the user turns ON the power of the communication terminal 15 at the home.

In Step S10, when the user sets the card 21 in the card reader 13, the card reader 13 in the communication terminal 15 reads the barcode data from the card 21. The communication terminal 15 accesses the URL conversion server 17 by sending the URL address of the URL conversion server 17 through the Internet. When receiving the permission of the connection from the URL conversion server 17, the communication terminal 15 transmits the own IP address and the barcode data (as the product identification information) to the URL conversion server 17.

In Step S20, the URL conversion server 17 converts the specific URL address corresponding to the barcode data received by searching the correspondence table between the barcode data (as the product identification information) that are stored in advance and the URL addresses. In this case, the specific URL address is assigned for the management server 19 for managing the pay homepage.

In Step S30, the URL conversion server 17 connects the management server 19 for managing the pay homepage by designating the specific URL address, and then transmits connection path data such as the IP address of the communication terminal 15, the URL address of the URL conversion server 17, and the barcode data (as the product identification information) to the management server 19, for example.

In Step S40, the management server 19 receives and judges connection path data through which various data are transmitted through the Internet 11 when this connection is through the Internet 11. In this case, when the connection path data include the URL address of the URL conversion server 17 that has been stored in the memory section 65 in advance, the management server 19 gives the permission of the connection to access the pay homepage to the device of the IP address that has not been stored as the information for the authorized user of the pay homepage. Then, the operation flow goes to Step S50.

On the other hand, the management server 19 transmits the message “You has a wrong connection path” to the device of the IP address in order to reject the connection when the connection path data do not include the URL address of the URL conversion server 17 stored in the memory section 65.

In Step S50, the management server 19 transmits the access permission information for the pay homepage to the communication terminal 15 designated by the IP address through the Internet 11. Further, the management server 19 indicates to open the pay homepage corresponding to the product identification information received to the homepage management section 67. As a result, the information of the pay homepage corresponding to the barcode data (as the product identification information) is transmitted to the communication terminal 15 through the communication processing section 61.

In Step S60, the communication terminal 15 receives the permission information to access the pay homepage from the management server 19 through the Internet 11. The information of this pay homepage corresponding to the barcode data (as the product identification information) is then displayed on the display section 31 in the communication terminal 15. The user can watch this pay homepage on the display section 31.

In summary, it is therefore possible for the user of the card 21 to easily access the pay homepage of the use-limitation by the following processes:

Reading the barcode data in the card by the communication terminal; transmitting the product identification information in the barcode data and the IP address of the communication terminal to the URL conversion server; obtaining the URL address of the management server corresponding to the product identification information transmitted from the communication terminal by searching the correspondence table; transmitting the product identification information and the IP address of the communication terminal (transmitted from the communication terminal) to the management server addressed by the URL address; and permitting to access the pay homepage of the use-limitation corresponding to the product identification information for the communication terminal of this IP address when the management server receives the product identification information through the URL conversion server.

As a result, it is possible for the users (who buy one of specific products or get specific services) to access the use-limitation homepage, for example, the pay homepage without any charge.

In addition, it is possible to access the pay homepage with easy operation and without inputting the URL address of this pay homepage even if this pay homepage is in a hierarchal data structure.

Moreover, because the manager of the pay homepage can provide the contents of the pay homepage to the purchasers of specific products or services, it is possible to easily expand the number of customers who want to access this pay homepage.

### Second Embodiment

The configuration of the use-limitation homepage providing system according to the second embodiment of the present invention has basically the same as that of the first embodiment shown in FIG. 1.

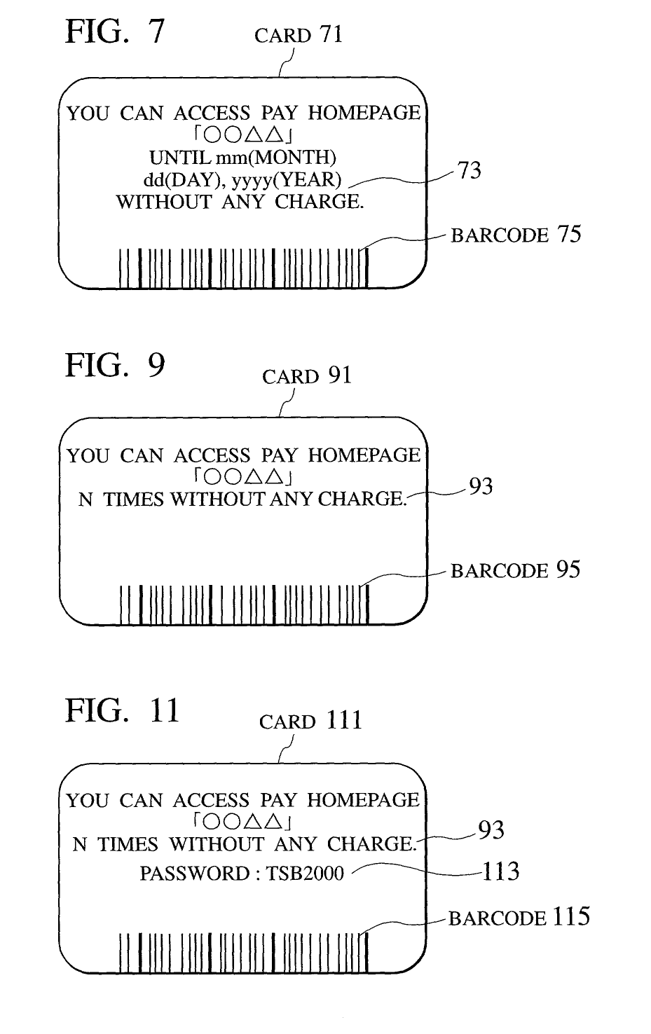

FIG. 7 is a diagram showing a characteristic of the card 71 to be used by the user in the second embodiment. As one feature of the second embodiment shown in FIG. 7, the character information 73 “You can access the pay homepage “◯◯ΔΔ” until MM(month) DD(day), YYYY(Year) (in month/day/year format) without any charge!” or another image information is printed on the card 71. This card 71 for accessing the pay homepage or the use-limitation homepage is attached to a product. When buying this product, the user gets this card 71. On this card 71, the barcode 75 including the product identification information for distinguish this product from other products has been printed.

The memory section 65 in the management server 19 stores expiration-date information in order to limit the access period of time corresponding to the product identification information for each product.

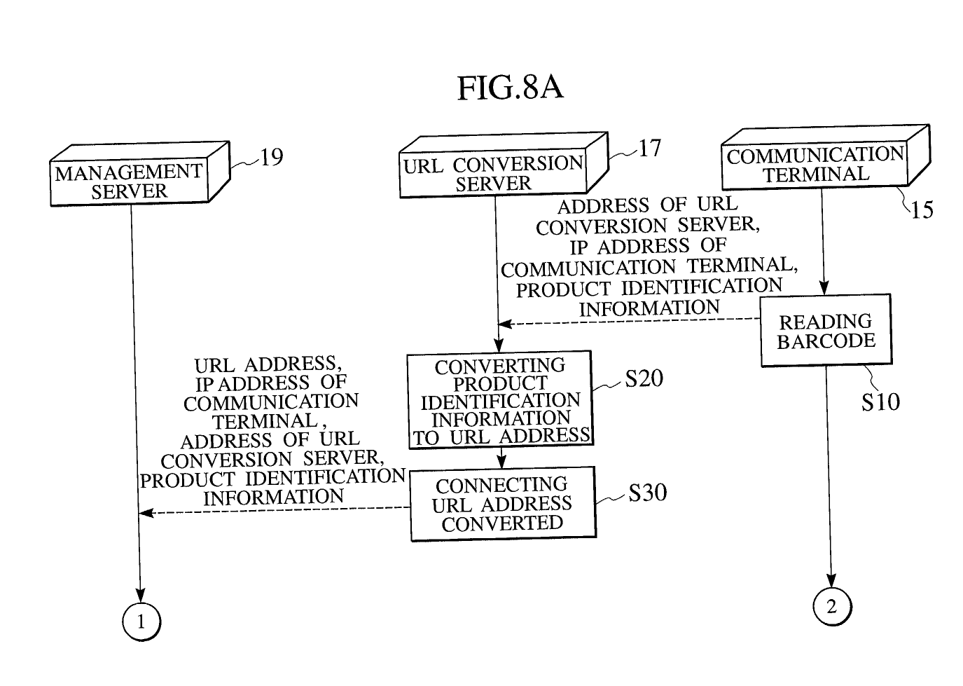

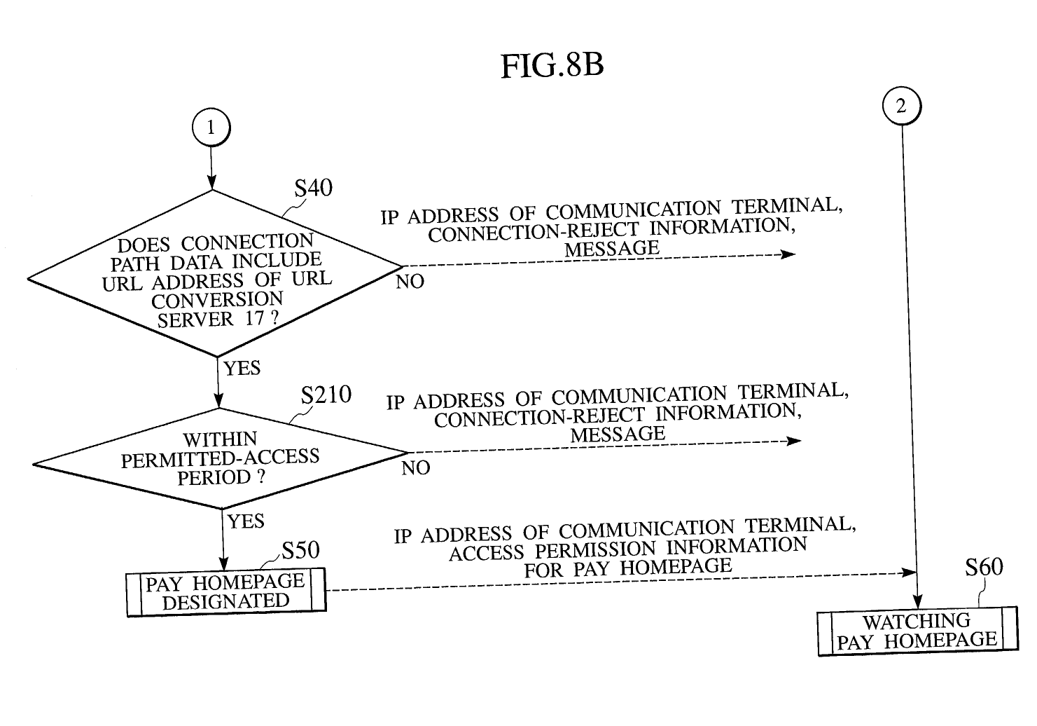

Next, a description will be given of the operation of the use-limitation homepage providing system of the second embodiment with reference to the flowchart of FIGS. 8A, 8B. FIGS. 8A, 8B are the flow chart depicting the procedure of the user-limitation homepage providing system according to the second embodiment.

The flowchart shown in FIGS. 8A, 8B has the same procedures of the flowchart shown in FIG. 6. In FIGS. 8A, 8B, the same steps are referred with the same reference characters in the flowchart of FIG. 6, and the explanation of them are omitted here for brevity.

As has been described in the first embodiment, in Step S40, the management server 19 receives and judges connection path data through which various data are transmitted through the Internet 11 when this connection is through the Internet 11. In this case, when the connection path data include the URL address of the URL conversion server 17 that has been stored in the memory section 65 in advance, the management server 19 gives the permission of the connection to access the pay homepage to the device (as the communication terminal) of the IP address that has not been stored as the information of the authorized user of the pay homepage. Then, the operation flow goes to Step S210.

In Step S210, the management server 19 reads the expiration-date information to limit the access period from the memory section 65 corresponding to the barcode data (as the product identification information) of the communication terminal 15 received from the URL conversion server 17. Then, the management server 19 judges whether or not the date information of today is within the expiration-data information by comparing the date information of today with the expiration-date information. Here, when the date-information of today is within the expiration-data information, the operation flow goes to Step S50, and the permission of the connection to access the pay homepage to the communication terminal 15.

On the other hand, when the date information of today is over the expiration-date information, the management server 19 transmits the rejection information to reject the connection to the pay homepage and the message “Access service with no charge was terminated.” to the device of the IP address.

Thus, by limiting the expiration-date to access the pay homepage without charge, it is possible to avoid the access to the pay homepage during a longer period of time.

### Third Embodiment

The configuration of the use-limitation homepage providing system according to the third embodiment of the present invention has basically the same as that of the first embodiment shown in FIG. 1.

FIG. 9 is a diagram showing a characteristic of the card 91 to be used by the user in the third embodiment. As one feature of the third embodiment shown in FIG. 9, the character information 93 “You can access the pay homepage N times without any charge!” or another image information is printed on the card 81. This card 91 for accessing the pay homepage or the use-limitation homepage is attached to a product. When buying this product, the user gets this card 91. On this card 91, the barcode 95 including the product identification information for distinguish this product from other products has been printed.

The memory section 65 in the management server 19 stores the access-number information indicating a current access-number in order to limit the number of the accesses corresponding to the product identification information for each product.

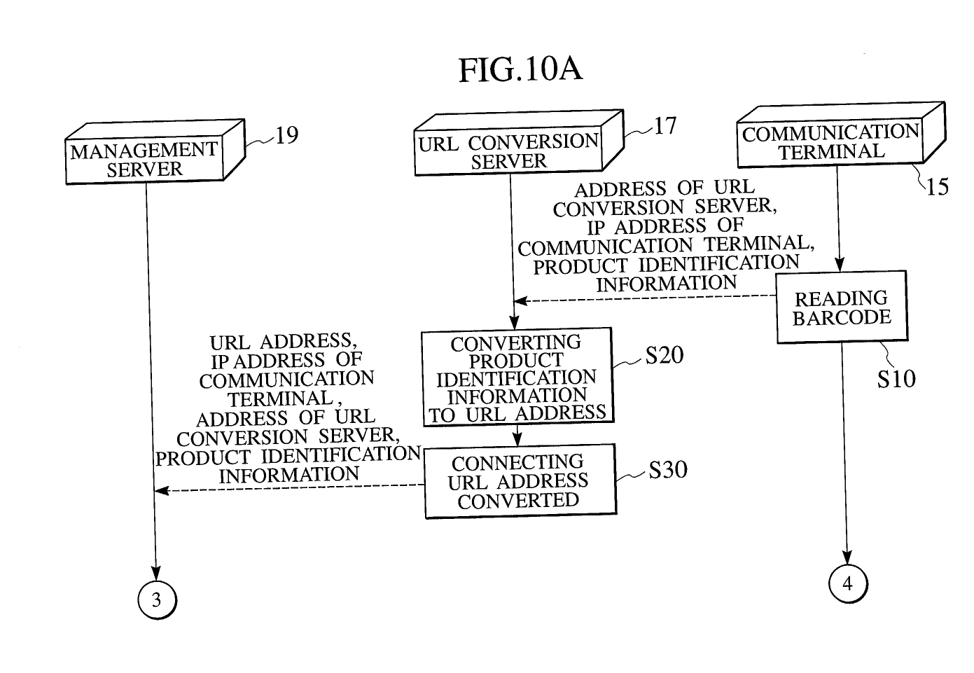

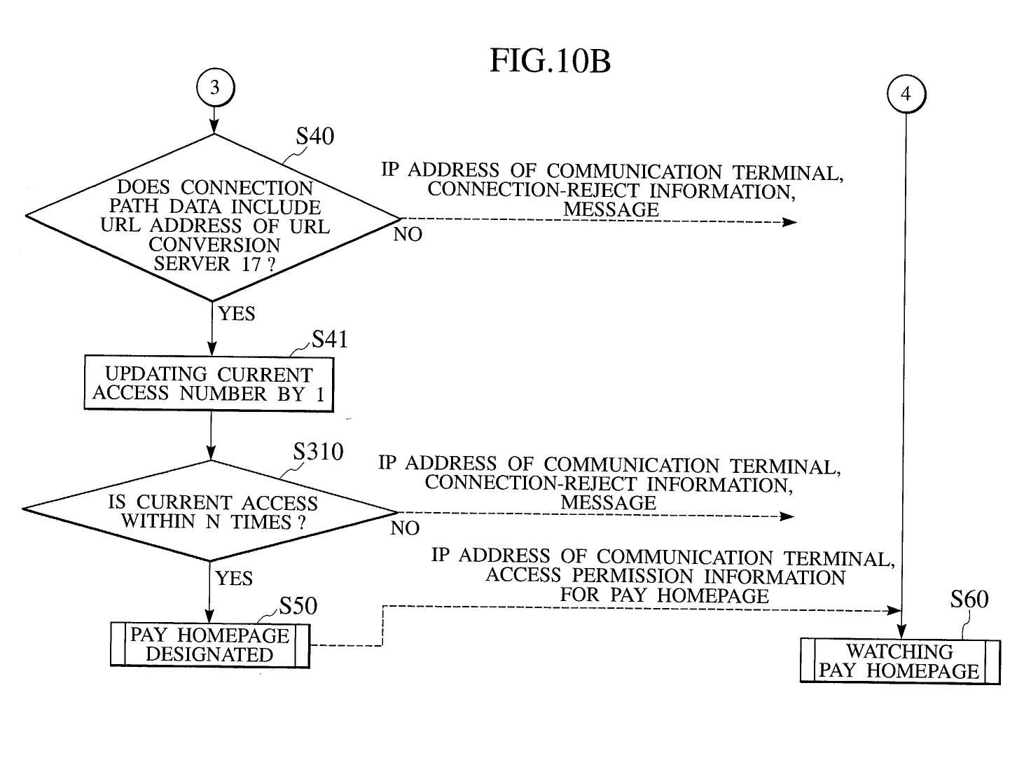

Next, a description will be given of the operation of the use-limitation homepage providing system of the third embodiment with reference to the flowchart of FIGS. 10A, 10B. FIGS. 10A, 10B are the flow chart depicting the procedure of the user-limitation homepage providing system according to the third embodiment.

The flowchart shown in FIGS. 1A, 10B basically has the same procedure of the flowchart shown in FIGS. 8A, 8B. In the flowchart shown in FIGS. 10A, 10B, the same steps are referenced with the same reference characters in the flowchart of FIGS. 8A, 8B, and the explanation of them are omitted here for brevity.

In Step S40, as has been described in the first and second embodiments, the management server 19 receives and judges connection path data through which various data are transmitted through the Internet 11 when this connection is through the Internet 11. In this case, when the connection path data include the URL address of the URL conversion server 17 that has been stored in the memory section 65 in advance, the management server 19 gives the permission of the connection to access the pay homepage to the device (as the communication terminal) of the IP address that has not been stored as the information of the authorized user of the pay homepage.

The management server 19 reads the access-number information, from the memory section 65, corresponding to the IP address of the communication terminal 15 received from the URL conversion server 17, and add the value “1” to the access-number information (access-number updating process), and stores it into the memory section 65 again (Step S41). Then, the operation flow goes to Step S310.

In Step S310, the management server 19 reads the access-number information corresponding to the IP address of the communication terminal 15 received from the URL conversion server 17 and then judges whether or not the access-number information is within the limit access-number “N” by comparing the access-number information with the limit access-number “N”. Here, when the access-number information is not reached to the limit access-number “N” (namely, over the number “N+1”), the operation flow goes to Step S50, and the management server 19 transmits the permission of the connection to access the pay homepage to the communication terminal 15.

On the other hand, when the access-number information is reached to or over the number “N+1”, the management server 19 transmits the rejection information to reject the connection to the pay homepage and the message “Access service with no charge was terminated.” is to the device of the IP address.

Thus, by limiting the number of accesses to access the pay homepage, it is possible to avoid the access-number over the limit access-number.

### Fourth Embodiment

The configuration of the use-limitation homepage providing system according to the fourth embodiment of the present invention has basically the same as that of the first embodiment shown in FIG. 1.

FIG. 11 is a diagram showing a characteristic of the card 91 to be used by the user in the fourth embodiment. As one feature of the fourth embodiment shown in FIG. 11, the character information 93 “You can access the pay homepage N times without any charge!” and a password that are different per card, or another image information is printed on the card 111. This card 111 for accessing the pay homepage or the use-limitation homepage is attached to a product. When buying this product, the user gets this card 111. On this card 111, the barcode 115 including the product identification information for distinguish this product from other products has been printed.

The memory section 65 in the management server 19 stores the access-number information and all passwords for accessing the pay homepages without any charge. The access-number information indicates a current access-number in order to limit the number of the accesses corresponding to the product identification information for each product.

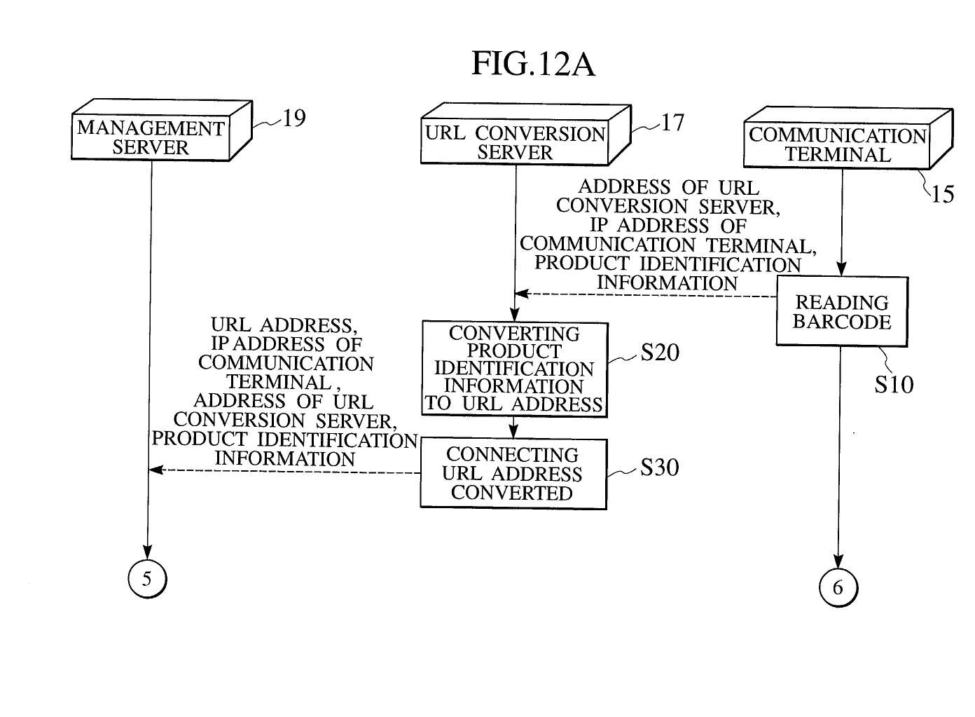

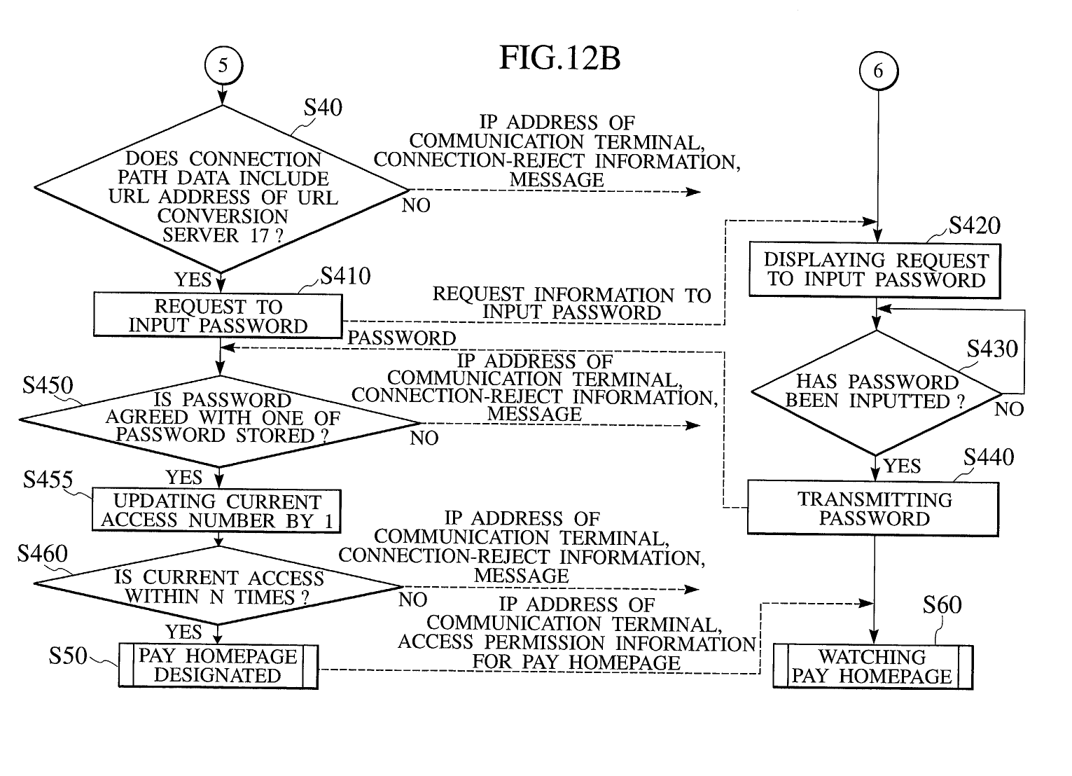

Next, a description will be given of the operation of the use-limitation homepage providing system of the fourth embodiment with reference to the flowchart of FIGS. 12A, 12B. FIGS. 12A, 12B are the flow chart depicting the procedure of the user-limitation homepage providing system according to the fourth embodiment.

The flowchart shown in FIGS. 12A, 12B basically has the same procedure of the flowchart shown in FIG. 6. In the flowchart shown in FIGS. 12A, 12B, the same steps are referenced with the same reference characters in the flowchart of FIG. 6, and the explanation of them are omitted here for brevity.

In Step S40, as has been described in the first and second embodiments, the management server 19 receives and judges connection path data through which various data are transmitted through the Internet 11 when this connection is through the Internet 11. In this case, when the connection path data include the URL address of the URL conversion server 17 that has been stored in the memory section 65 in advance, the operation flows goes to Step S410.

In Step S410, in order to request to input the password to the communication terminal 15, the management server 19 transmits password-input request information to the received IP address of the communication terminal 15. Here, in Step S420, the communication terminal 15 that has received the password input request information transmitted from the management server 19 displays the message “Input the password described in the card through the keyboard” through the display section 31.

In Step S430, the communication terminal 15 waits to perform the following operation until the user inputs the password through the keyboard 43. When the user inputs the password through the keyboard 43, the communication terminal 15 transmits this password through the public network communication section 33.

When receiving the password from the communication terminal 15, in Step S450, the management server 19 judges whether this received password is agreed with the passwords that have been stored in the memory section 65 in advance. When the password transmitted from the communication terminal 15 is not agreed with any passwords stored in the memory section 65, the management server 19 transmits the message “Your have wrong password!” to the communication terminal 15 through the Internet 11. When receiving this message, the communication terminal 15 indicates that the operation flow goes to Step S420 in order to input the correct password.

On the other hand, when the password transmitted from the communication terminal 15 is the correct password, that is, when the password is agreed with one of the passwords stored in the memory section 65, the operation flow goes to Step S455.

In Step S455, like Step S45 in the third embodiment, the management server 19 reads the access-number information, from the memory section 65, corresponding to the IP address of the communication terminal 15 received from the URL conversion server 17, and adds the value “1” to the access-number information (access-number updating process), and stores it into the memory section 65 again (Step S455). Then, the operation flow goes to Step S460.

In Step S460, the management server 19 reads the access-number information, from the memory section 65, corresponding to the received password, and judges whether the access-number information is not over the limit access-number “N”. When it is within the limit access-number “N”, the operation flow goes to Step S50, and the management server 19 transmits the permission information of the connection to access the pay homepage to the communication terminal 15. Then, the management server 19 reads the access-number information from the memory section 65, and adds the value “1” to this access-number information, and stores it into the memory section 65 again. Thereby, the operation of the management server 19 is completed.

On the other hand, when the access-number information is reached to or over the number “N+1”, the management server 19 transmits the rejection information to reject the connection to the pay homepage and the message “Access service with no charge was terminated.” is to the device (the communication terminal 15) of the IP address.

As described above, it is possible to prevent the access of the pay homepage of the use-limitation type without pay from users who are not authorized by requesting to input the password described in the card to the communication terminal, and by permitting the access to the pay homepage of the use-limitation type only when the password is equal to the passwords that have been stored in advance in the memory section.

In the fourth embodiment, when the number of users (or customers) who want to make a contract for reading the pay homepage with the owner or the provider of the pay homepage is increased by using the cards attached in the products and using the URL conversion server, it is possible for the provider of this pay homepage to pay the cost of the URL conversion operation to the corporation that operates the URL conversion server. As a result, this corporation operating the URL conversion server can get the fee from the provider of this pay homepage according to the number of the URL conversions, for example.

As set forth in detail, according to the present invention, the communication terminal reads a barcode printed on the card, and transmits identification information included in the barcode and IP address of the communication terminal to the URL conversion server. The URL conversion server obtains the URL address of the management server corresponding to the identification information received from the communication terminal, and transmits the identification information and the IP address of the communication terminal to the management server addressed by the URL address. When receiving the identification information through the URL conversion server, the management server sends the permission to access the use-limitation homepage corresponding to the identification information to the communication terminal of the IP address. It is thereby possible for the user of the card to access the use-limitation homepage with easily operation. As a result, it is possible for the users (who buy one of specific products or get specific services) to access the use-limitation homepage, for example, the pay homepage without any charge.

In addition, it is possible to access the pay homepage with easy operation and without inputting the URL address of this pay homepage even if this pay homepage is in a hierarchal data structure.

Moreover, according to the present invention, because the manager of the pay homepage can provide the contents of the pay homepage to the purchasers of specific products or services, it is possible to easily expand the number of customers who want to access this pay homepage.

Furthermore, according to the present invention, by limiting the expiration-date to access the pay homepage without charge, it is possible to avoid the access to the pay homepage during a longer period of time.

Moreover, according to the present invention, by limiting the number of accesses to access the pay homepage, it is possible to avoid the access-number over the limit access-number.

Still further, according to the present invention, it is possible to prevent the access of the pay homepage of the use-limitation type without pay from users who are not authorized by requesting to input the password described in the card to the communication terminal and by permitting the access to the pay homepage of the use-limitation type only when the password is equal to the passwords that have been stored in advance in the memory section.

While the above provides a full and complete disclosure of the preferred embodiments of the present invention, various modifications, alternate constructions and equivalents may be employed without departing from the scope of the invention. Therefore the above description and illustration should not be construed as limiting the scope of the invention, which is defined by the appended claims.

What is claimed is:

1. A use-limitation homepage providing system which connects a communication terminal to a URL conversion server and to a management server in order and provides a use-limitation homepage in homepages which are stored in the management server to the communication terminal through an information network, wherein the communication terminal comprises:
a barcode reader which reads a barcode printed on a card on which the barcode including identification information is printed; and
a first communication processing section which transmits the identification information in the card and IP address of the communication terminal to the URL conversion server,
the URL conversion server comprises:
an address conversion section which converts the identification information to URL address of the management server corresponding to this identification information transmitted from the communication terminal; and
a second communication processing section which transmits the identification information transmitted from the communication terminal and the IP address of the communication terminal to the management server addressed by the URL address of the management server,
and
the management server comprises:
an access permission section which transmits permission information regarding the permission to access the use-limitation homepage corresponding to the identification information to the communication terminal addressed by the IP address when the management server receives the identification information through the URL conversion server.

2. The use-limitation homepage providing system as claimed in claim 1, wherein the access permission section limits an access permission period where the user can access the use-limitation homepage only during this permission period.

3. The use-limitation homepage providing system as claimed in claim 1, wherein the access permission section limits the number of accesses to the use-limitation homepage a predetermined times.

4. The use-limitation homepage providing system as claimed in claim 1, further comprising a request section which requests to input a password printed on the card to the communication terminal,
wherein the access permission section permits the access of the use-limitation homepage to the communication terminal only when the password transmitted from the communication terminal is equal to one of passwords which are registered in advance.

5. The use-limitation homepage providing system as claimed in claim 2, further comprising a request section which requests to input a password printed on the card to the communication terminal,
wherein the access permission section permits the access of the use-limitation homepage to the communication terminal only when the password transmitted from the communication terminal is equal to one of passwords which are registered in advance.

6. The use-limitation homepage providing system as claimed in claim 3, further comprising a request section which requests to input a password printed on the card to the communication terminal,
wherein the access permission section permits the access of the use-limitation homepage to the communication terminal only when the password transmitted from the communication terminal is equal to one of passwords which are registered in advance.
